(19) United States
(12) Patent Application Publication
(10) Pub. No.: US 2011/0280987 A1
(43) Pub. Date: Nov. 17, 2011

(54) USE OF BROWN MIDRIB CORN SILAGE IN BEEF TO REPLACE CORN

(75) Inventor: Karl E. Nestor, JR., Wooster, OH (US)

(73) Assignee: AGRIGENETICS, INC., Indianapolis, IN (US)

(21) Appl. No.: 13/104,162

(22) Filed: May 10, 2011

Related U.S. Application Data
(60) Provisional application No. 61/334,381, filed on May 13, 2010.

(51) Int. Cl. A23K 1/06; A23L 1/31; A23K 1/16; A23K 1/18

(52) U.S. Cl. 426/2; 426/641; 426/623; 426/624

(57) ABSTRACT

This disclosure concerns finishing rations for increasing the meat quantity of a silage-fed animal, and methods of using the same. In some embodiments, a corn silage produced from a corn variety exhibiting reduced lignin content (e.g., BMR corn) is used to replace conventional silage in a finishing ration. In some embodiments, corn silage produced from a corn variety exhibiting reduced lignin content (e.g., BMR corn) is used to replace grain corn in a finishing ration.

### CROSS-REFERENCE TO RELATED APPLICATION

This application claims the benefit of U.S. Provisional Patent Application Ser. No. 61/334,381, filed May 13, 2010, the disclosure of which is hereby incorporated herein in its entirety by this reference.

### TECHNICAL FIELD

The present disclosure relates generally to animal feed compositions, animal feed supplements, and methods for increasing meet production from animals. Particular embodiments relate to methods for improving animal performance, for example, by increasing the feed efficiency of a finishing ration fed to animals being prepared for meat production.

### BACKGROUND

Lignins are universal components in plants that form cross-links with carbohydrates, such as hemicelluloses in the cell wall. Lignin polymers lower fiber digestion in ruminants, and the degree of lignifications may be inversely proportional to forage crop digestibility. Cherney et al. (1991) Adv. Agron. 46:157-98. Plants containing a brown midrib mutation exhibit altered lignin composition and digestibility. In corn, at least four independent brown midrib mutations have been identified. Kuc et al. (1968) Phytochemistry 7:1435-6. These mutations, termed “bm1, bm2, bm3, and bm4,” all exhibit decreased lignin content when compared to control corn. bm3 mutations include insertions and deletions within the caffeic acid O-methyltransferase (COMT, EC 2.1.1.6) gene. Morrow et al. (1997) Mol. Breeding 3:351-7; Vignols et al. (1995) Plant Cell 7:407-16.

Agriculturally important uses of corn (maize) include silage. Silage is fermented, high-moisture fodder that can be fed to ruminants. It is fermented and stored in a process called ensilage or silaging, and is usually made from corn or other grass crops, including sorghum or other cereals, using the entire green plant. Silage may be made, e.g., by placing cut green vegetation in a silo, by piling it in a large heap covered by plastic sheet, or by wrapping large bales in plastic film. The ensiled product retains a much larger proportion of its nutrients than if the crop had been dried and stored as hay or stover. Bulk silage is commonly fed to dairy cattle, while baled silage tends to be used for beef cattle, sheep, and horses. Since silage goes through a fermentation process, energy is used by fermentative bacteria to produce volatile fatty acids, such as acetate, propionate, lactate, and butyrate, which preserve the forage. The result is that the silage is lower in energy than the original forage, since the fermentative bacteria use some of the carbohydrates to produce the volatile fatty acids.

Corn silage is a popular forage for ruminant animals because it is high in energy and digestibility and is easily adapted to mechanization from the stand-crop to time of feeding. Corn silage generally is slightly brown to dark green in color, and has a light, pleasant smell. Feeding brown midrib (BMR) corn silage to lactating dairy cows has been shown to increase dry matter intake (DMI) and milk yield. Grant et al. (1995) J. Dairy Sci. 78:1970-80; Oba and Allen (2000) J. Dairy Sci. 83:1333-41; Oba and Allen (1999) J. Dairy Sci. 82:135-42. However, BMR corn silage reduced average daily gain and feed efficiency (G:F) in beef cows, compared to corn silage from a conventional corn variety. Tjardes et al. (2000) J. Anim. Sci. 78:2957-65.

### DISCLOSURE

Corn co-products, mainly distillers grains and corn gluten feed, are being used in feedlot diets in the Midwest. The production of meat requires large amounts of forage. To assure the availability of such forage, increasing amounts of arable land are being used for forage production, instead of producing food for humans. Furthermore, the total amount of arable land is limited, and continues to decrease due to the increasing worldwide population. Successful methods for increasing the gain:feed ratio (G:F) of animals being fed a finishing ration in preparation for meat production will result in a desirable decrease in demand for arable land devoted to forage production.

Methods are disclosed for increasing the meat quantity of a silage-fed animal, for example by increasing G:F for corn silage. A beef finishing ration comprising corn silage, wherein the corn silage replaces the grain corn in a conventional beef finishing ration is also disclosed. Also disclosed are meat and meat products produced from an animal fed a finishing ration according to the disclosure or according to a method the disclosure.

The foregoing and other features will become more apparent from the following detailed description of several embodiments, which proceeds with reference to the accompanying figures.

### BRIEF DESCRIPTION OF THE FIGURES

FIG. 1 includes a table showing effects of feedlot diets containing BMR silage on animal performance and carcass characteristics according to an embodiment of the invention.

FIG. 2 includes a description of several feedlot diets according to particular embodiments of the invention.

FIG. 3 includes an analysis of several diet samples according to an embodiment of the invention.

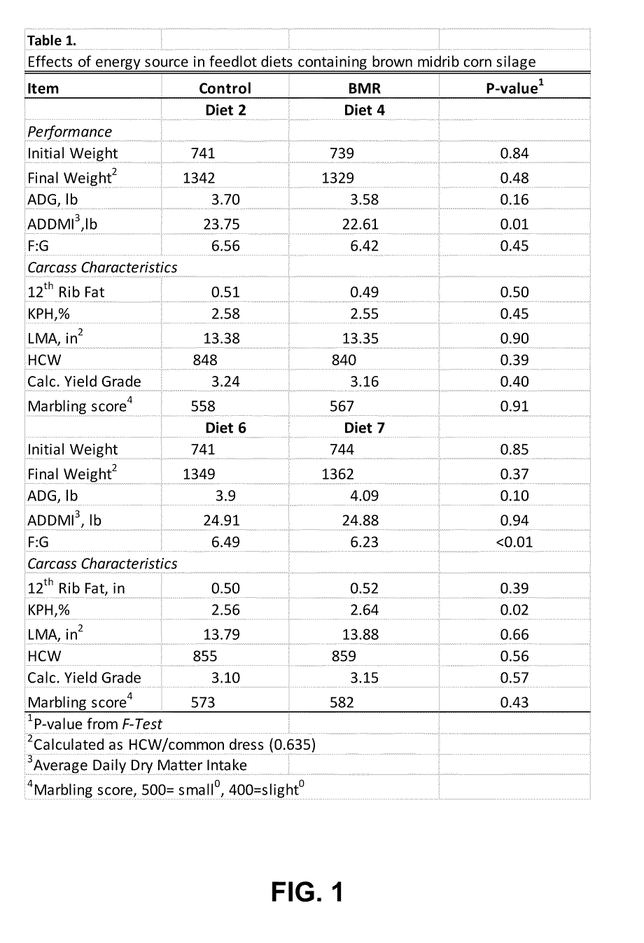

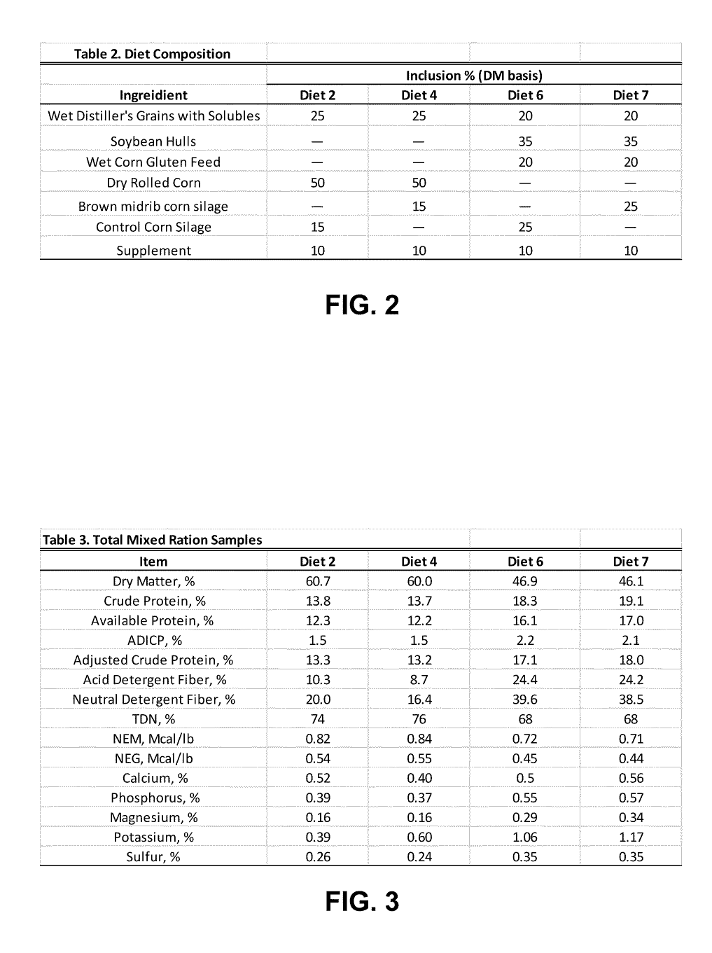

### DETAILED DESCRIPTION

### I. Overview of Several Embodiments

Disclosed herein are methods for increasing the meat quantity of a silage-fed animal that take advantage of the surprising discoveries that silage from corn varieties exhibiting reduced lignin content improves daily gain and feed efficiency when compared to conventional corn silage in a finishing ration, and that corn silage can effectively replace grain corn in a beef finishing ration. In some embodiments, the method comprises providing silage produced from a corn plant variety exhibiting decreased lignin content, feeding the animal with the silage produced from a corn plant variety exhibiting decreased lignin content, and producing meat or meat products from the animal. A decreased lignin content may be measured in comparison to corn silage variety TMF2Q753, or another standard corn silage variety. As such, corn varieties exhibiting decreased lignin content are known in the art. In these and further embodiments, disclosed methods may be used in the feeding of any silage-fed animal, for example, cattle, sheep, swine, horses, goats, bison, yaks, water buffalo, and deer. In particular embodiments, the silage-fed animal may be a ruminant.

In some embodiments, silage produced from a corn plant variety exhibiting decreased lignin content may be prepared by ensiling corn plants with altered caffeic acid O-methyltransferase (COMT) activity, compared to wild-type corn plants. Non-limiting examples of corn plants with altered COMT activity include plants with a brown midrib mutation, such as, brown midrib 1 (bm1), brown midrib 2 (bm2), brown midrib 3 (bm3), and brown midrib 4 (bm4). One non-limiting example of a corn plant with a bm3 mutation, wherein the corn plant exhibits decreased lignin content, is F2F635. In these and further embodiments, the silage produced from a corn plant variety exhibiting decreased lignin content may comprise at least about 15% of the dry matter in the animal's diet (for example, at least about 25%).

In some embodiments, methods provided for increasing the meat quantity of a silage-fed animal further comprise an act selected from the group consisting of: placing the silage in a container configured for shipping, and associating indicia with the silage, wherein the indicia is capable of directing an end-user on how to administer the silage to the animal. Thus, kits comprising silage are provided, such that the kits allow an end-user to increase the meat quantity of a silage-fed animal.

Also disclosed are beef finishing rations, wherein the beef finishing ration comprises corn silage, but the beef finishing ration does not comprise grain corn.

Also disclosed are meat and meat products prepared from an animal that has been fed silage according to the disclosure.

### II. Abbreviations

ADICP acid detergent insoluble crude protein

BMR brown midrib

COMT caffeic acid O-methyltransferase

DM dry matter

DM % percent composition of the dry matter

DMI dry matter intake

G:F gain:feed ratio (inverse of F:G, or feed:gain ratio)

HCW hot carcass weight

KPH estimated percentage of kidney, heart, and pelvic fat

LMA longissimus muscle area

MS marbling score

NDF neutral detergent fiber

NEm energy needed for maintenance

NEg energy needed for body growth

TDN total digestible nutrient

### III. Terms

Corn plant: As used herein, the term “corn plant” refers to a plant of the species, Zea mays (maize).

BMR corn: As used herein, the term “BMR corn” refers to corn varieties that contain a brown midrib mutation. BMR corn varieties typically exhibit a reddish brown pigmentation of the leaf midrib. BMR corn is also typically characterized by lower lignin content, higher fiber digestibility, and higher dry matter intake. Non-limiting examples of BMR corn varieties include F2F297, F2F383, F2F488, F2F449, F2F566, F2F610, F2F622, F2F665, F2F633, F2F682, F2F721, F2F700, and F2F797.

Dry matter: As used herein, the term “dry matter” refers to any feedstuff, including forage.

Meat: As used herein, the term “meat” refers to animal tissue used, for example, as food. The term “meat” typically refers to skeletal muscle and associated fat, but may also refer to non-muscle organs, including lungs, livers, skin, brains, bone marrow, kidneys, testicles, intestines, etc.

Neutral detergent fiber: As used herein the term “neutral detergent fiber” (NDF) refers to a measure of slowly digested material across a wide range of feeds. NDF levels in forage increase as the plant matures. Average levels of NDF in grass silage may be approximately 55 percent DM (550 g/kg DM). The content of NDF in a total ration may be between 35-50% DM. Diets with less than 32 percent NDF may cause problems with acidosis. Diets that contain over 50 percent NDF may be restricted in their intake potential.

Silage: As used herein, the term “silage” refers to a certain type of storage forage. Generally, silage is made from plants (e.g., corn plants) in a process called ensilage. During this process, plants or plant parts undergo anaerobic fermentation caused by indigenous microorganisms (e.g., one or more strains of lactic acid bacteria, for example, Lactobacillus spec.) converting sugars to acids and exhausting any oxygen present in the crop material, which depletion of oxygen preserves the forage in conjunction with bacteria-generated volatile fatty acids, such as acetate, propionate, lactate, and butyrate. Silage is widely used for feeding milk and meat producing animals, such as dairy cattle and beef cattle.

The term “producing silage” describes the process of how to obtain silage suitable for feeding to a meat-producing animal. Generally, silage is produced from plants, for example, corn plants, by chopping the harvested plant biomass with a forage harvester.

Fiber source: As used herein, the term “fiber source” refers to a material obtained from a plant or microbial source, which material contains edible fibers. Practical, but not limiting examples of fiber sources include, the hulls of agricultural seed products such as from soy beans, or from grains such as rice, wheat, corn, barley; the stalks from such grains (straw); vegetable/plant-based soap stocks, corn stover, which typically includes the stalks, husks and leaves from a harvested corn plant; processed component fractions of agricultural products that are enriched in fiber, for example corn gluten feed; leaf material from any plant source, and distillers dried grains with or without solubles dried thereon. Thus, in particular examples, a fiber source may include, for example, mixtures of the following: alfalfa, barley products (e.g., straw), beet pulp, soy hulls, switch grass, corn fiber, soy fiber, cocoa hulls, corn cobs, corn husks, corn stove, wheat straw, wheat chaff, rice straw, flax hulls, soy meal, corn meal, wheat germ, corn germ, shrubs, and grasses. For the purpose of clarity in the present disclosure, distillers dried grains (with or without solubles) and distillers grains (with or without solubles) contain fiber, but are not considered “fiber sources.” Distillers dried grains (with or without solubles) and distillers grains (with or without solubles) are considered “corn co-products,” as set forth below.

Corn co-product: As used herein the term “corn co-product” refers to products that remain following the wet milling or dry milling of corn. Non-limiting examples of corn co-products include corn gluten, distillers grains, distillers grains plus solubles, distiller dried grains, distillers dried grains with solubles, condensed distillers solubles, bran cake, modified distillers grains, modified distillers grain plus solubles.

Supplement: As used herein, the term “supplement” refers to any ingredient included in a feed mix to enhance the nutritional value of the feed mix. Commonly used supplements include protein (e.g., soybean meal or urea), minerals (e.g., bone meal), energy (e.g., animal fat), and vitamins.

### IV. Use of Brown Midrib Corn Silage In A Beeffinishing Ration

A. Overview

Described herein is a general strategy for increasing the quantity of meat or meat product obtainable from a silage-fed animal, as well as beef finishing rations suitable for feeding to a silage-fed animal. Particular examples exploit the unexpected finding that BMR corn silage can effectively replace grain corn in a beef finishing ration. Also, particular examples exploit the unexpected finding that use of BMR corn silage (instead of conventional corn silage) in a beef finishing ration improves, e.g., the daily gain and feed efficiency of the finishing ration. For example, a beef finishing ration containing BMR corn silage, may have a higher feed efficiency than comparable finishing rations that do not contain BMR corn silage. The feed efficiency may be reported as G:F (gain:feed ratio), or similarly as F:G (feed:gain ratio, which is the inverse of G:F). In particular examples, the average daily gains observed for silage-fed animals fed a BMR corn silage-containing finishing ration are approximately equivalent to the average daily gains observed for silage-fed animals fed a comparable finishing ration that includes grain corn as an energy source.

B. Brown Midrib Corn

Brown midrib corn plants are characterized by a brown pigmentation in the leaf midrib at the V4 to V6 stage and a light brown coloration of the pith after tasselling. Brown midrib hybrid corn contains a gene mutation that causes lower lignin content in corn plant tissue, for example, a bm2 mutation, or a bm3 mutation. The brown midrib3 gene is located on the short arm of chromosome 4, and the bm3 allele is recessive. The brown midrib2 gene is located on the long arm of chromosome 1, and the bm2 allele is also recessive.

Lignin polymers limit the digestibility of the fiber in the corn plant. The reduced lignin in brown midrib corn results in silage with fiber that is more digestible than normal corn. Animal feeding trials have shown about 10 percent greater intake and increased milk production with brown midrib corn silage (BMR silage), as compared to normal silage. However, BMR corn silage is thought to lead to reduced average daily gain and feed efficiency (G:F), compared to normal corn silage. Tjardes et al. (2000) J. Anim. Sci. 78:2957-65. Additionally, many Brown midrib hybrid corn hybrid lines (BMR corn) frequently have been found to be low yielding. BMR corn has also typically been associated with forage lodging and lack of standability.

C. Production of Silage

Ensilage compresses chopped silage. The cells of the corn plant are still alive and metabolically active, and ongoing metabolism by plant cells and microorganisms in the compressed silage forms carbon dioxide and heat by using air trapped in the ensiled plant material. Anaerobic metabolic conditions develop as the level of carbon dioxide in the silage increases. Desirable bacteria begin the fermentation process when plant respiration stops. If too much air is present, or if carbon dioxide escapes, an anaerobic condition may fail to develop. In this case, respiration may continue, and the respiring plant cells may use too much sugar and carbohydrates. This may waste nutrients needed by desirable bacteria to preserve the plant material as silage, and may yield an inferior silage. To avoid this undesirable effect, packing and covering of the silage immediately after filling may be important.

Once respiration by the plant cells ceases, acetic and lactic acids are produced by bacteria that feed on the available starches and simple sugars in the ensiled corn. To promote growth of desirable bacteria, the silage may contain a low amount of air, temperatures between 80° and 100° F., and starches and sugars for food. Fermentation may continue until the acidity of the silage is high enough to stop bacterial growth. In some examples, the desired degree of acidity is a pH of about 4.2. This degree of acidity may occur within 3 weeks after the silo is filled.

Seepage may occur if moisture in the forage is excessively high. Seepage involves the drainage of leachate (excess moisture from silage and pulp) out of the silage, which generally enters the environment as a serious pollutant. Through seepage, desirable components (e.g., nitrogenous compounds, such as protein; and minerals) of the silage may be lost. Seepage generally reaches its peak on about the fourth day after ensiling. Therefore to avoid, for example, the loss of desirable silage components from the silage, moisture content of forage going into the silo may be chosen to be sufficiently low to reduce or prevent seepage loss. However, silage that is too dry may not pack adequately, and may also exhibit a high loss of desirable components from the silage as a consequence of excessive fermentation and molding.

Plants may be ensiled at a dry matter content of about 30-40% to enable an optimal fermentation process, and to minimize losses during fermentation. To reach a dry matter content of about 30-40%, it may be desirable to let the plant material dry down in a field after mowing and before chopping with, for example, a forage harvester. When preparing corn silage, the grain may be harvested together with the rest of the plant. To increase the availability of nutrients in the silage for uptake in the intestinal tract of a silage-fed animal, it may be desirable to crush the grain during the chopping process.

Harvested plant material may be transferred into a silo. Non-limiting examples of silos that may be useful for silage preparation include: a bunker silo, a silage heap, a concrete stave silo, or a tower silo. The plant material is compacted in the silo to remove air from the plant material, and enable anaerobic fermentation. It may be desirable to seal the silo with a plastic silage film, depending on the type of silo used. Use of a plastic cover on a trench silo, a bunker silo, or a large-diameter tower silo, may materially cut feed losses. Typically, the cover is applied immediately after the last load of plant material is packed in the silo, and the plastic covers are weighted to hold them firmly on the surface of the silage. Alternatively, the plant material may be prepared for fermentation during ensiling by baling the plant material, and wrapping the bales in silage film for sealing. On trench or bunker silos, it may be desirable to mound or crown the forage. This may facilitate drainage of rain water off the silo.

Additives may optionally be added to the plant material to improve fermentation. Examples of plant material additives that may be desirable in particular applications include microbial additives, such as Lactobacillus spp. and other inoculants; acids such as propionic acid, acetic acid or formic acid; or sugars. As will be readily understood by those of skill in the art, other methods for producing silage other than those specifically recited herein may also be used.

One advantage of silage production is that the process may have no influence on the composition, the amount, or availability of nutritive substances contained within the plant material used for producing the silage. On the contrary, purposes of the process itself are generally to both keep the quality of the plant material as it was prior to using such material for producing silage, and to preserve the positive properties of the plant material for an extended period of time. In this way, the plant material can be used as forage long after the plant material has been harvested.

Corn may be harvested for silage after the ear is well-dented, but before the leaves dry to the point that they turn brown. At this stage of growth, the ear may have accumulated most of its potential feeding value, but there may also have been little loss from the leaves and stalks. Thus, the quantity and quality of corn silage may be at its peak when the plant material is harvested during this stage. Ears usually will be well-dented when the ears are between 32-35% moisture. As time elapses after the ear has become well-dented, the feeding value of the plant material may decrease while field losses may increase. Corn harvested for silage at the milk stage (grain head releases a white liquid when opened) or dough stage (grain head begins to turn a doughy consistency) may yield less feed nutrients per acre than if it was harvested later. Plant material from corn may also ferment improperly in a silo if it is harvested too soon.

Maturity usually refers to the time when the ear has accumulated nearly all of its dry matter production potential. Temperatures during growth may influence the maturity rate of the grain, particularly during the autumn. For example, the ear's full dry matter potential may not be achieved if there are excessively cool temperatures and/or cloudy weather. Corn silage that is cut late and has brown and dead leaves and stalks may make adequate silage, but total production per acre may be sharply reduced. Significant field losses have been found when silage is made late into the fall or early winter. Also, a reduction in the amount of dry matter stored in the silo may be found with respect to silage that is cut late.

Corn that has been damaged, for example, by drought, high temperatures, blight, frost, or hail, may be salvaged for silage. However, the quality of such salvaged silage may not be as high as silage produced from undamaged corn that has reached the dent stage. The feeding value of the silage may depend upon both the state of the corn's development, and how the corn is handled after it has been damaged. Common observations of silage from immature corn include: higher moisture; fermentation in a different manner than mature corn; sour odor; and increased laxative effect. Corn that has experience from frost typically has a low carotene content. It will dry out quickly and lose leaves. Thus, it may be desirable to add water to corn that has frosted and become too dry. It may also be desirable to add water to drought corn.

It may be desirable for immature corn that has been damaged by extremely high temperatures to not be ensiled immediately. Immature, heat-damaged corn may never produce ears, but some additional stalk growth may result from delaying harvest. Additional stalk growth will result in additional feed. If corn is harvested for silage too soon after the plants have been extensively damaged by heat, the stalk may have too much moisture to produce a high-quality silage. Corn harvested too soon after extensive heat damage that has too much moisture may also lose nutrients through seepage.

Silage may also be produced from corn that has been damaged by leaf diseases such as the Southern Corn Leaf Blight. The Blight organism does not survive the ensiling process, and is further not believed to be toxic to silage-fed animals. However, in severe and unlikely cases, a secondary mold infection on damaged areas of the plant may produce a harmful toxin.

Possible problems with silage made from salvaged corn include its lack of energy content due to reduced grain formation, and improper fermentation resulting from excessive dryness of the damaged plant. As is known by those of skill in the art, these problems may be corrected, at least in part, by supplementation with an additional energy source, and addition of moisture, respectively.

Corn silage may be cut into particles that are ½″ to ¾″ in length. Particles of this size may pack more firmly, and may additionally be more palatable to silage-fed animals. Very finely cut silage that is shorter than ½″ in length may be made with a recutter. Use of very finely cut silage increases the amount of dry matter that can be stored, e.g., in a silo. However, very finely cut silage may be less palatable to an animal that is to be fed the silage.

If silage is too dry, it may be desirable to add water, for example, to establish airtight conditions. Generally, four gallons of water may be added per ton of silage for each 1 percent desired rise in moisture content. It is understood that more or less water may be required, and measurements may be taken during the ensiling process to ensure that enough, but not too much, water is added. The water may be added as the silo is being filled. If the water is added after the silo is filled, it may seep down the silo walls, and therefore not permeate the silage mass. This seepage may cause leaching of silage nutrients, and may break the air seal and lead to improper fermentation.

Frozen silage may present a problem, particularly with respect to trench silos or bunker silos. While freezing does not impair the preservation of undisturbed silage, frozen silage may cause digestive disturbances when eaten by a silage-fed animal. Thus, it may be desirable to thaw silage before feeding it to an animal.

High-quality silage may be made without the addition of any additives or preservatives. However, additives may be added to silage to increase one or more characteristics of the silage. For example, molasses and grain may be added to corn forage at the time of ensiling.

With large-capacity silos and high-speed filling methods, distribution and packing of silage in silos should be monitored. Improper distribution and packing may cause excessive seepage, poor fermentation, and/or losses in storage capacity. Half the capacity of a cylindrical silo is in the silo's outermost edge. For example, for a cylindrical silo that is 14′ in diameter, half its capacity is in the outermost 2′ of its diameter. If material in this outside area is packed too loosely, the capacity of the silo may be significantly reduced. Thus, tower silos may be equipped with a distributor that facilitates proper silage distribution and packing.

A loss of nutrients occurs in all silage during the ensiling process, due to the presence of living microorganisms that carry out the fermentation process. The amount of nutritional value lost during the ensiling process depends upon, inter alia, the exclusion air during filling, and the prevention of carbon dioxide loss. Carbon dioxide is necessary to arrest respiration of the ensiled plant cells; and to prevent seepage loss, undesirable fermentation, and/or spoilage due to exposure of the plant material surface. Therefore, good ensiling practices generally lead to higher quality silage with a maximal nutrient content.

D. BMR Silage In Finishing Ration

BMR corn silage may be chopped into longer particles than normal corn silage, whether it is processed or not. NDF digestibility of BMR silage may be approximately 10 percentage points higher than with normal silage. The composition of freshly made silage is not necessarily reflective of the composition of feed that the silage-fed animal will eat. Therefore, fermented samples may be analyzed after a period of time in the silo. For example, samples may be analyzed after at least two weeks, or at least two months, in the silo.

Once BMR silage has been prepared, and the BMR silage has been determined to be ready to be fed to an animal, the BMR silage may be included in a finishing ration to be fed to an animal that will be used for meat, or meat product, production. In some examples, the finishing ration comprising BMR silage may not comprise grain corn, for example, dry rolled corn, or ground corn. Typical finishing rations comprise at least about 11% protein, about 60 MCal of Net Energy, about 0.5% Calcium, about 0.35% Phosphorous, and about 0.6% Potassium. In some examples, it is an advantage that a finishing ration exhibits a higher feed efficiency (G:F). In particular examples, a finishing ration that does not comprise grain corn may result in average daily gains in an animal fed the finishing ration that are comparable to the average daily gain that would result from a normal finishing rations that uses grain corn as an energy source.

In some examples, a finishing ration is produced using silage from corn having a reduced lignin content, wherein the finishing ration comprises between about 15% and about 30% corn silage. Thus, a finishing ration may comprise, for example, 13%, 14%, 15%, 16%, 17%, 18%, 19%, 20%, 21%, 22%, 23%, 24%, 25%, 26%, 27%, 28%, 29%, 30%, 31%, 32%, or 33% corn silage. In particular examples, a finishing ration is produced using BMR corn silage. In some examples, a finishing ration comprising at least one fiber source is produced. Thus, a finishing ration may comprise, for example, one, two, three, four, or more than four fiber sources. In some examples, a finishing ration comprising at least one corn co-product is produced. Thus, a finishing ration may comprise, for example, one, two, three, four, or more than four corn co-products. In some examples, a finishing ration comprising less than 60% dry matter is produced. In further examples, a finishing ration comprises less than 55% dry matter. In some specific examples, a finishing ration comprises less than 50% dry matter. Thus, a finishing ration may comprise, for example, 59%, 58%, 57%, 56%, 55%, 54%, 53%, 52%, 51%, 50%, 49%, 48%, 47%, 46%, 45%, 44%, 43%, 42%, 41%, or 40% dry matter. In some examples, a finishing ration comprises silage produced from a corn plant variety exhibiting decreased lignin content (e.g., BMR corn silage) in amounts greater than about 15% of the dry matter in the animal's diet. In some specific examples, a finishing ration comprises silage produced from a corn plant variety exhibiting decreased lignin content in amounts greater than about 25% of the dry matter in the animal's diet. Thus, a finishing ration may comprise, for example, 15%, 16%, 17%, 18%, 19%, 20%, 21%, 22%, 23%, 24%, 25%, 26%, 27%, 28%, 29%, or 30% corn silage produced from a corn plant variety exhibiting a decreased lignin content (DM %).

### EXAMPLES

### Example 1

### Materials and Methods

The effects of feeding control and BMR corn silages at 15 or 25% of a feedlot diet were evaluated. Both corn varieties were harvested when they reached approximately 30% DM and were stored in bunker silos. The corn silage was chopped to a theoretical one-half inch cut and both were run through a kernel processor. The bunkers were covered with plastic and weighted with tires. The silages were then allowed to ferment approximately 60 days before the trial began.

Three hundred eighty-three head of Simmental X Angus steers were delivered from three ranches from Montana and one from Virginia. Steers were vaccinated for Bovine Respiratory Syncytial Virus, IBR, BVD, PI3, and Pasteurella prior to shipping. Steers were implanted successively with Component TE-IS (80 mg trenbolone acetate, 16 mg estradiol, 29 mg tylosin tartate; VetLife, Overland Park, Kans.) and Component® TE-S (120 mg trenbolone acetate, 24 mg estradiol, 29 mg tylosin tartate; VetLife, Overland Park, Kans.). Steers were randomly allotted to pens and stratified by weight. Two diets with differing energy sources were compared (Table 2). Diets 2 and 6 contained the control corn silage variety, TMF2Q753, at 15 and 25% of the diet DM, respectively. Diets 4 and 7 contained a BMR corn silage variety, F2F635, at 15 and 25% of the diet DM, respectively. Steers were housed on slatted floors in feedlot pens. In each pen, there were 5 Growsafe® units (GrowSafe® Systems Ltd., Airdrie, Alberta, Canada) used for recording daily feed intake. There were 39 or 40 steers in each pen, which therefore provided 8.0 steers per GrowSafe® feeder.

### Data Collection

Steer weight, hip height, and ultrasonic measurements of backfat thickness, marbling score, and longissimus muscle area (LMA) were recorded approximately every 42 days throughout the feeding period to evaluate live animal performance. Cattle were harvested in two groups to optimize carcass value. All cattle were slaughtered at the same commercial packing facility (Tyson™ Fresh Meats, Joslin, Ill.). Carcass measurements were assessed by trained personnel, and included: hot carcass weight (HCW), marbling score (MS), longissimus muscle area (LMA), estimated percentage of kidney, heart and pelvic fat (KPH), and 12th rib fat. Diet samples were sent to Dairy One Forage Test Laboratory (Ithaca, N.Y.) for analysis (Table 3). Data were analyzed as a one-way analysis of variance using the GLM procedure of Statistical Analysis Software (SAS® Institute, Inc., Cary, N.C.). Main effect means for all analyses were separated using the respective F-tests, and were significant (P<0.05).

### Example 2

### Finishing Rations Comprising BMR Silage

The control corn silage (TMF2Q753) averaged 30.1% DM, and had a pH of 4.1 coming out of the silo. The BMR silage (F2F635) averaged 29.0% DM and had a pH of 3.8 coming out of the silo.

As expected, initial weights for animals in the control and BMR silage groups were not different (Table 1). Adjusted final body weights were also not different for any of the comparisons. Average daily dry matter intake was higher for cattle consuming diet 2 compared to diet 4. When the two silages were fed at 25% of the diet DM, intakes were almost identical (diets 6 vs. 7). There was a tendency (P=0.10) for ADG to be different between diets 6 and 7. Feed conversion was improved for diet 7, compared to that observed for diet 6 (P<0.01). While not intending to be tied to any particular theory, this improvement may be due to higher fiber digestibility. Percentage of pelvic, kidney, and heart fat was lower for steers fed diet 6, compared to that observed for diet 7. These results indicate that control and brown midrib corn silages fed as 15% of diets resulted in similar feedlot performance and carcass merit. However, improved feed conversion was observed when brown midrib corn silage was fed as 25% of the diet.

While the present invention has been described herein with respect to certain preferred embodiments, those of ordinary skill in the art will recognize and appreciate that it is not so limited. Rather, many additions, deletions, and modifications to the preferred embodiments may be made without departing from the scope of the invention as hereinafter claimed. In addition, features from one embodiment may be combined with features of another embodiment while still being encompassed within the scope of the invention as contemplated by the inventors.

What is claimed is:

1. A method of increasing the meat quantity of a silage-fed animal, the method comprising:
providing silage produced from a corn plant variety exhibiting decreased lignin content; and
feeding the animal with the silage produced from a corn plant variety exhibiting decreased lignin content.

2. The method of claim 1, wherein the corn plant variety exhibiting decreased lignin content is a BMR variety.

3. The method of claim 1, wherein the silage-fed animal is selected from the group consisting of cattle, sheep, swine, horses, goats, bison, yaks, water buffalo, and deer.

4. The method of claim 1, wherein the silage-fed animal is a ruminant.

5. The method of claim 2, wherein the silage produced from a corn plant variety exhibiting decreased lignin content is prepared by ensiling corn plants having altered caffeic acid 0-methyltransferase activity, compared to wild-type corn plants.

6. The method of claim 2, wherein the corn plant variety exhibiting decreased lignin content comprises a brown midrib gene selected from the group consisting of brown midrib 1 (bm1), brown midrib 2 (bm2), brown midrib 3 (bm3), and brown midrib 4 (bm4).

7. The method of claim 6, wherein the corn plant variety exhibiting decreased lignin content comprises a brown midrib gene selected from the group consisting of brown midrib 3-1 (bm3-1), and brown midrib 3-2 (bm3-2).

8. The method of claim 6, wherein the corn plant variety exhibiting decreased lignin content is F2F635.

9. The method of claim 1, further comprising an act selected from the group consisting of:
placing the silage in a container configured for shipping, and
associating indicia with the silage, wherein the indicia is capable of directing an end-user on how to administer the silage to the animal.

10. The method of claim 1, wherein the silage produced from a corn plant variety exhibiting decreased lignin content is greater than 15% of the dry matter in the animal's diet.

11. The method of claim 10, wherein the silage produced from a corn plant variety exhibiting decreased lignin content is at least about 25% of the dry matter in the animal's diet.

12. A meat product prepared from the animal of claim 1.

13. A beef finishing ration comprising corn silage, wherein the beef finishing ration does not comprise grain corn.

14. The beef finishing ration of claim 13, further comprising:
at least one fiber source;
at least one corn co-product; and
at least one supplement.

15. The beef finishing ration of claim 13, wherein the beef finishing ration comprises between about 15% and about 30% corn silage.

16. The beef finishing ration of claim 13, wherein the corn silage is BMR corn silage.

17. The beef finishing ration of claim 13, wherein the corn silage is non-BMR corn silage.

18. The beef finishing ration of claim 13, wherein at least one fiber source comprises soybean hulls.

19. The beef finishing ration of claim 13, wherein at least one corn co-product comprises a corn co-product selected from the group consisting of wet corn gluten feed and wet distiller's grains with solubles.

20. The beef finishing ration of claim 13, further comprising less than 60% dry matter.
